(19) United States
(12) Patent Application Publication
(10) Pub. No.: US 2025/0091276 A1
(43) Pub. Date: Mar. 20, 2025

(54) EXTRUSION DEVICE AND METHOD FOR MANUFACTURING AN ARTICLE HAVING A CAVITY

(71) Applicant: Collin Lab & Pilot Solutions GmbH, Maitenbeth (DE)

(72) Inventor: Friedrich KASTNER, Grieskirchen (AT)

(21) Appl. No.: 18/577,000

(22) PCT Filed: Jul. 4, 2022
(86) PCT No.: PCT/EP2022/068409

§ 371 Date: Jan. 5, 2024

(30) Foreign Application Priority Data
Jul. 7, 2021 (DE) 102021117604.2

(51) Int. Cl. B29C 48/92; B29C 48/10; B29C 48/255

(52) U.S. Cl. CPC B29C 48/92; B29C 48/10; B29C 48/2552; B29C 2948/92123; B29C 2948/92447; B29C 2948/92514; B29C 2948/926; B29C 2948/92904

(57) ABSTRACT

An extrusion device for producing an object having a cavity, in particular a tube or a container, includes a material feed that opens into an extrusion nozzle, and a support gas feed that opens into a blow-in opening for introducing support gas into the interior of the resulting object, wherein the support gas feed has at least one valve for regulating the support gas, characterized in that at least one valve for regulating the support gas is a proportional valve which can be regulated by a controller.

### RELATED APPLICATIONS

This application is a national stage under 35 U.S.C. § 371 of International Application No. PCT/EP2022/068409, filed Jul. 4, 2022, which claims priority of German Patent Application No. 10 2021 117 604.2, filed Jul. 7, 2021.

### TECHNICAL FIELD

The field of the present disclosure relates to an extrusion device, in particular a blown film extrusion device, and a method for producing an object having a cavity.

### BACKGROUND

It is known that during extrusion, for example in the production of blown films or tubes, inflation systems are used that create a bubble or cavity in the resulting strand by means of overpressure. A so-called supporting air is blown into the interior of the object being produced.

DE102017008803A1 discloses a device for manufacturing and filling container products, in which a tube of plasticized plastic material is extruded from an extrusion head along a tube guide into a mold. Process gas is introduced into the interior of the tube by means of a process gas feed device.

US 2002/076459 A1 discloses a system for starting an extruded film tube in a blown film extrusion device having a subsystem for changing an amount of air in the extruded film and a subsystem for executing program instructions that control the operation of the subsystem for changing an amount of air.

U.S. Pat. No. 4,402,656 A discloses an internally cooled blown film system for the production of plastic tubes in which the flow rate of the continuous stream of internal cooling air is made directly dependent on the positional deviation of the tube wall by non-contact energy beam sensor means.

The extrusion blow molding systems and blown film systems—especially with low blowing volumes—according to the state of the art have the disadvantage that the—sometimes manual—control of the valves leads to inaccurate, varying and only imprecisely reproducible properties (in particular dimensions such as diameter, thickness, etc.) of the resulting products. Particularly, in the case of high-precision components this often leads to errors or undesirable effects, such as the bubble expanding or the bubble breaking out in regions of the strand that have not yet solidified.

A need remains for a device and a method with which the quality and precision of the resulting products can be sustainably improved by specifically influencing the support gas flow. Properties, in particular dimensions such as (outer) diameter or wall thickness, should be constant and reproducible along the extruded strand. The solution should be reliable and cost-effective and enable simplified application.

### SUMMARY

According to the present disclosure, an extrusion device for producing an object having a cavity, in particular a tube or a container, comprises a material feed that opens into an extrusion nozzle, and a support gas feed that opens into a blow-in opening for introducing support gas, preferably air, into the interior of the resulting object, wherein the support gas feed has at least one valve for regulating the support gas, wherein the at least one valve for regulating the support gas is preferably a proportional valve that can be regulated by a controller.

On the one hand, the use of a (in particular electrically controllable) proportional valve ensures that the support gas flow can be continuously adjusted and therefore that the support gas flow can be precisely controlled, as a result of which the pressure inside the resulting object or extrudate can meet the specific requirements of the process flow (e.g. can be maintained constant). On the other hand, the controller enables the proportional valve to be regulated and not merely controlled. This means that it can also react automatically to current conditions (support gas flow) and/or properties (extrudate). Deviations from a desired behavior can be corrected or compensated for immediately by (re-)adjusting the proportional valve.

Any suitable controller, in particular a PI controller, a PID controller and/or a non-linear controller, can be used as a controller for the proportional valve.

The material supplied can be any material that can be brought into a specific shape by the extrusion process, in particular plastic material that can be plasticized or liquefied due to its (thermoplastic) properties and, in this state, can be conveyed through an extrusion nozzle.

The extrusion nozzle and the blow-in opening can be arranged in a common extrusion head. In this case, after exiting the extrusion head, the material flow and the support gas flow have essentially the same direction. The cross-section of the outlet opening of the extrusion nozzle is in particular circumferential, preferably ring-shaped, and surrounds the region in which the blow-in opening is located.

The extrusion device is preferably a device in which the extrudate is a continuous product, in particular a (film) tube or tubular structure, whereby the continuous product usually has no inherent dimensional stability. No further molds are used downstream of the extrusion nozzle, i.e., after leaving the extrusion nozzle, the extrudate is shaped or held in shape solely by the support gas introduced. The extrusion device is therefore preferably a blown film or blown tube extrusion device, whereby both terms are also used synonymously.

However, it cannot be ruled out that the extrusion device may have a mold downstream of the extrusion nozzle into which the material can be extruded. In this case, the support gas can press the extrudate against the inner wall of the mold.

As already mentioned above, devices and methods according to the present disclosure are particularly suitable for the manufacture of endless products (e.g. tubes). There are also no restrictions with regard to dimensions. Thus, thin tubes (e.g. film tubes or blown films) can be produced as well as tubes or tubular objects with a greater wall thickness.

The extrusion device can have a (preferably heated) material reservoir from which the material feed extends to the extrusion nozzle.

A preferred embodiment is characterized in that the extrusion device for setting the proportional valve has a control circuit—comprising a controller—in which control circuit a detected actual value of a property of the object, in particular a diameter of the object, and/or an actual value of the support gas flow acts back on the control variable of the proportional valve. The proportional valve can be readjusted immediately, in particular in real time, due to the feedback effect of detected actual values on the control circuit. This measure allows the proportional valve to be reliably regulated, which prevents effects such as expanding of the support gas (bubble) or breaking out of the support gas in regions of the extrudate that have not yet solidified.

A preferred embodiment is characterized in that the reference variable of the control circuit is a target diameter of the object and/or a target diameter of the object adjusted by a ramp generator. The diameter of the resulting object depends heavily on the support gas feed. The extrudate will inflate or collapse if the support gas flow is not set correctly. Detecting the diameter therefore establishes a direct association with the support gas.

The extrusion device may be characterized in that the proportional valve has a non-linear gas flow characteristic in at least one operating range. Devices and methods according to the present disclosure make it possible, for example, to use an electrically controlled proportional valve instead of one or more simple solenoid valves. However, these valves often do not exhibit linear response behavior. This means, for example, that with analog control (e.g. 0-10V) there are no linear volume flows or mass flows. However, such non-linearities can be compensated for by regulation using a controller.

The extrusion device may be characterized in that the control circuit has a feedforward control—superimposed on the controller—whereby the feedforward control is preferably configured to compensate for a non-linear gas flow characteristic of the proportional valve. The feedforward control not only improves the control behavior, but in particular allows non-linearities, which are often inherent in proportional valves, to be addressed. In this case, it is a so-called linearized feedforward control. For at least one control range, preferably for the entire operating range, of the proportional valve, the non-linear gas flow characteristic of the proportional valve can therefore be mapped—directly or indirectly—in the feedforward control. The stability of the control and consequently the stability of the support gas flow or gas pressure within the resulting object can be greatly improved by this measure. The non-linear characteristic of the proportional valve can be compensated for by such a linearized feedforward control.

The characteristic curve of the valve behavior can, for example, either be linearized by one or more interpolation points or determined via an identification run.

Optionally, the (additional) valve(s) can also be controlled manually via the controller. A separate mode can be used to adjust the controller, in which the volume flow is set to a defined value.

A preferred embodiment is characterized in that a ramp generator is connected upstream of the controller for target value adjustment, whereby preferably the target diameter and the actual diameter of the object are input variables of the ramp generator. In order to be able to realize large target value changes of the diameter, the diameter change can optionally be stepped or extended in time by a ramp generator or similar.

A preferred embodiment is characterized in that at least one sensor for detecting a property of the support gas flow, preferably the volume flow and/or the mass flow and/or the gas pressure of the support gas, is arranged in the support gas feed, with the detected property or properties of the support gas flow preferably serving as input variable(s) for the control circuit and/or the feedforward control. Since the gas flow is decisive for the properties and quality of the resulting object, the process can be significantly improved by a control loop using such sensors. The sensor data (e.g. volume flow or mass flow) can be used to set the control characteristic of the proportional valve to be linear or to follow a specific characteristic. This measure can also be used to compensate for the non-linear behavior of a proportional valve.

A preferred embodiment is characterized in that the extrusion device has at least one sensor for detecting a property of the object, in particular the diameter of the object, with the detected property or properties of the object preferably serving as input variable(s) for the control circuit and/or the feedforward control. Here, a feedback loop with high stability is created directly on the basis of the properties of the object and thus on the basis of the immediate consequences of a specific gas flow.

A preferred embodiment is characterized in that a discharge line branches off from the support gas feed to discharge support gas, whereby the discharge line is preferably connected to a negative pressure generator, in particular a vacuum pump. This allows an excess of support gas to be discharged if required. The control range is thus extended and the time latency of the closed-loop control is reduced if the pressure inside the extrudate is too high.

A preferred embodiment is characterized in that the discharge line is connected to the support gas feed via the proportional valve, whereby the discharge line is decoupled from the support gas feed in a first control range of the proportional valve and is coupled to the support gas feed in a second control range of the proportional valve. With this preferred measure, the proportional valve takes on a further function, namely the discharge of supporting air. This extends the operating range as well as the stability and reliability of the production process.

In an alternative embodiment, the discharge line opens into the support gas feed in a region between the proportional valve and the blow-in opening. A separate valve can be provided in the discharge line to regulate the discharged support gas.

A preferred embodiment is characterized in that the control circuit is configured in such a way that in a region of the control range, preferably starting in the region of the middle of the control range, support gas is discharged by coupling the discharge line to the support gas feed, which preferably reduces the pressure inside the resulting object and/or maintains it at a target value.

A preferred embodiment is characterized in that the discharge line is connected to a negative pressure generator, in particular a vacuum pump, whereby the negative pressure generator is preferably controlled by the controller of the control circuit.

A preferred embodiment is characterized in that the support gas feed has a gas pressure source. The gas pressure source can, for example, be a pressurized gas reservoir or a device for generating (or increasing) the gas pressure, in particular a blower or a compressor.

A preferred embodiment is characterized in that in at least one position, preferably in a control range, of the proportional valve, both a section of the support gas feed extending between the proportional valve and the gas pressure source and the discharge line are flow-coupled to the blow-in opening. In this way, the support gas flow passing through the blow-in opening can be very finely regulated.

A preferred embodiment is characterized in that in at least one operating state of the extrusion device, both the gas pressure source via the at least partially open proportional valve and the negative pressure generator—preferably via at least one at least partially open valve—are fluidically coupled to the blow-in opening, so that support gas can be simultaneously supplied via the support gas feed and discharged via the discharge line, whereby preferably the ratio between the supplied support gas and the discharged support gas can be regulated by means of the proportional valve and/or a valve connected in the discharge line and/or a negative pressure generator that can be regulated. This measure allows the support gas flowing through the blow-in opening into the extrudate to be regulated particularly precisely. With the simultaneous discharge of gas, not only can the control range be extended, but the flow parameters can also be adjusted particularly quickly in order to prevent or quickly compensate for deviations from an ideal state of the extrudate.

A preferred embodiment is characterized in that at least one valve—preferably controlled manually and/or by a separate controller—is connected in the discharge line to control the support gas discharge. These measures can be used—particularly for special applications—to switch the (negative) pressure in the discharge line on or off or to preset it to a specific value.

A preferred embodiment is characterized in that, in addition to the proportional valve, the support gas feed has at least one further valve—preferably one that can be controlled manually and/or by a separate controller—for controlling the support gas, with the further valve preferably being connected between the proportional valve and the gas pressure source. These measures can be used—particularly for special applications—to switch the (excess) pressure in the support gas feed—upstream of the proportional valve—on or off or to preset it to a specific value.

A preferred embodiment is characterized in that the extrusion nozzle and the blow-in opening are integrated in an extrusion head. The material flow and gas flow essentially point in the same direction.

The present disclosure further encompasses a method for producing an object having a cavity, in particular a tube or a container, by means of an extrusion device, wherein material is supplied to an extrusion nozzle via a material feed and support gas is introduced into the interior of the resulting object via a blow-in opening by means of a support gas feed, wherein the support gas feed has at least one valve for regulating the support gas, characterized in that at least one valve for regulating the support gas feed is a proportional valve which can be regulated by a controller.

A preferred embodiment is characterized in that the proportional valve is set by a control circuit—comprising a controller—in which control circuit a detected actual value of a property of the object, in particular a diameter of the object, and/or an actual value of the support gas flow acts back on the control variable of the proportional valve.

The method may be characterized in that the control circuit has a feedforward control—superimposed on the controller—whereby a non-linear gas flow characteristic of the proportional valve is preferably compensated for by means of the feedforward control.

A preferred embodiment is characterized in that a discharge line for discharging support gas is connected to the support gas feed via the proportional valve, whereby the proportional valve is regulated between a first control range, in which the discharge line is decoupled from the support gas feed, and a second control range, in which the discharge line is coupled to the support gas feed, in order to regulate the support gas flow.

A preferred embodiment is characterized in that in a region of the control range, preferably starting in the middle of the control range, support gas is discharged by coupling the discharge line to the support gas feed, which preferably reduces the pressure inside the resulting object and/or keeps it at a target value.

It is therefore preferable that—e.g. approximately in the middle of the control range—a counterflow is built up through the discharge line (e.g. by means of a vacuum pump), which equalizes the pressure relative to the bubble to 0 bar or another target value. If the valve is now opened further, inflation takes place. If the valve is closed further, suction takes place as the negative pressure (vacuum) then prevails. All valves can be fine-tuned using additional manual valves.

A preferred embodiment is characterized in that in at least one operating state of the extrusion device, both the gas pressure source via the at least partially open proportional valve and the negative pressure generator—preferably via at least one at least partially open valve—are flow-coupled to the blow-in opening, so that support gas is simultaneously supplied via the support gas feed and discharged via the discharge line, with the ratio between the supplied support gas and the discharged support gas preferably being regulated by means of the proportional valve and/or a valve connected in the discharge line and/or a negative pressure generator that can be regulated. This measure allows the support gas flowing through the blow-in opening into the extrudate to be regulated particularly precisely. The control range can be extended with the simultaneous discharge of gas.

A preferred embodiment is characterized in that the extrusion device is configured according to the present disclosure.

The controller controls the—optionally mentioned—negative pressure generator (e.g. vacuum pump) either permanently or there is a switchover depending on the desired operating point. This allows a very wide control range to be realized. The control of the feed of support gas can be superimposed on this. Simple PID controllers as well as non-linear controllers can be used. As already mentioned, a feedforward control, which can also depend on the desired operating point, can be superimposed on the controller for dynamic and precise control.

### BRIEF DESCRIPTION OF THE DRAWINGS

For a better understanding of the invention, embodiments are explained in more detail with the aid of the following figures.

They each show in a highly simplified, schematic representation:

FIG. 1 a schematic representation of an extrusion device

FIG. 2 a schematic representation of the control circuit of an embodiment of the extrusion device

FIG. 3 an embodiment of an extrusion device

### DETAILED DESCRIPTION OF EXEMPLARY EMBODIMENTS

By way of introduction, it should be noted that in the differently described embodiments, the same parts are provided with the same reference signs or the same component designations, whereby the disclosures contained in the entire description can be transferred analogously to the same parts with the same reference signs or the same component designations. The positional details selected in the description, such as top, bottom, side, etc., also refer to the directly described and illustrated figure and these positional details are to be transferred analogously to the new position in the event of a change in position.

The embodiment examples show possible embodiment variants, whereby it should be noted at this point that the invention is not limited to the specifically illustrated embodiment variants thereof, but rather various combinations of the individual embodiment variants with one another are also possible and this variation possibility lies within the ability of the person skilled in the art working in this technical field due to the teaching on technical action by the present invention.

The scope of protection is determined by the claims. However, the description and the drawings must be used to interpret the claims. Individual features or combinations of features from the various embodiments shown and described may constitute independent inventive solutions. The object underlying the independent inventive solutions can be taken from the description.

All indications of value ranges in the present description are to be understood as including any and all subranges thereof, e.g. the indication 1 to 10 is to be understood as including all subranges, starting from the lower limit 1 and the upper limit 10, i.e. all subranges start with a lower limit of 1 or greater and end with an upper limit of 10 or less, e.g. 1 to 1.7, or 3.2 to 8.1, or 5.5 to 10.

Finally, for the sake of order, it should be noted that some elements have been shown out of scale and/or enlarged and/or reduced in size to make the configuration easier to understand.

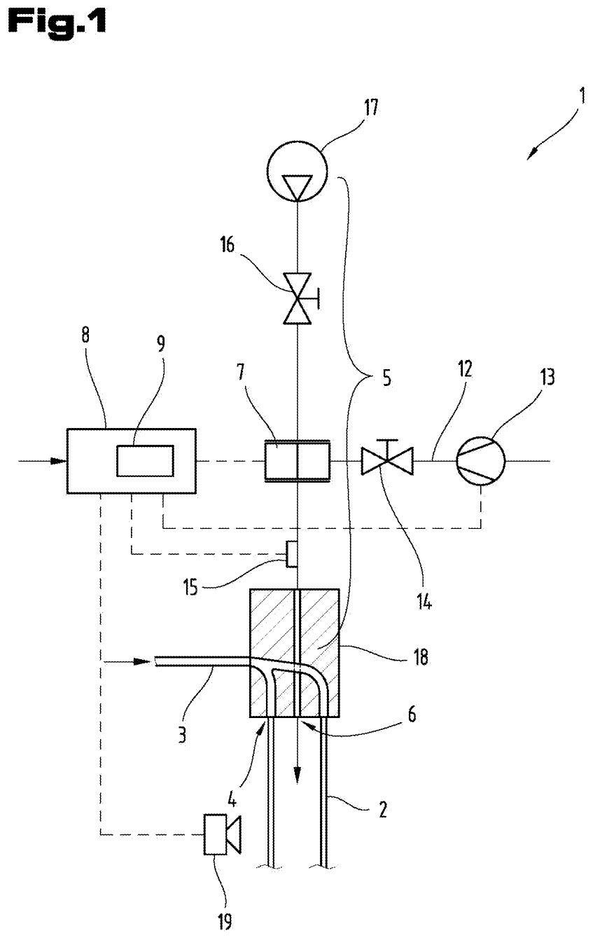

FIG. 1 shows an extrusion device 1 in the form of a blown film extrusion device for producing an object 2 having a cavity, in particular a tube, a blown film or a container, preferably made of plastic. This produces a continuous product which is subject to requirements in terms of diameter, wall thickness, etc. A material feed 3, which starts from a material reservoir not shown, opens into an extrusion nozzle 4 of the extrusion head 18. A support gas feed 5, which opens into a blow-in opening 6, serves to introduce support gas into the interior of the resulting object 2 (extrudate). The support gas feed 5 has at least one valve 7, 16 for regulating the support gas, wherein at least one valve for regulating the support gas is a proportional valve 7 which can be regulated by a controller 9.

FIG. 1 also shows that the support gas feed 5 has a gas pressure source 17—here in the form of a compressor. The gas pressure source 17 does not necessarily have to be part of the extrusion device, but could also be provided externally and could only be connected to the support gas feed.

The extrusion nozzle 4 and the blow-in opening 6 are integrated in an extrusion head 18.

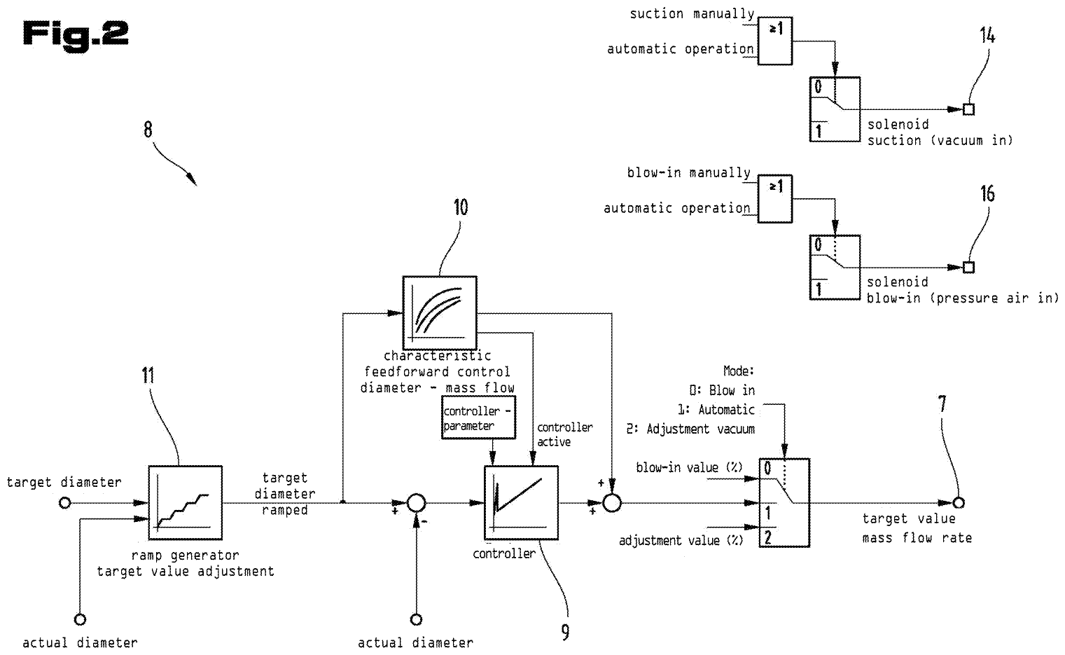

In the preferred embodiment shown, the extrusion device 1 has a control circuit 8—comprising a controller 9—for setting the proportional valve 7, in which control circuit 8 a detected actual value of a property of the object 2, in particular a diameter of the object 2, and/or an actual value of the support gas flow acts back on the control variable of the proportional valve 7 (see also FIG. 2).

As can be seen from FIG. 2, the reference variable of the control circuit 8 can be a target diameter of the object and/or a target diameter of the object 2 adjusted by a ramp generator 11. In the case of a ramp generator 11 connected upstream of the controller 9 for target value adjustment, the predetermined target diameter and the actual diameter of the object can be input variables of the ramp generator 11.

Since the proportional valve 7 has a non-linear gas flow characteristic in at least one operating range, it is preferable for the control circuit 8 to have a feedforward control 10 that is superimposed on the controller 9. This can be configured in such a way as to compensate—in whole or in part—for a non-linear gas flow characteristic of the proportional valve 7. The control circuit 8 is shown in detail in FIG. 2.

It is preferable if—as shown in FIG. 1—at least one sensor 15 is arranged in the support gas feed 5 for detecting a property of the support gas flow, preferably the volume flow and/or the mass flow and/or the gas pressure of the support gas. The detected characteristic(s) of the support gas flow can serve as input variable(s) for the control circuit 8 and/or the feedforward control 10.

Alternatively or additionally, the extrusion device 1 can have at least one sensor 19 (e.g. in the form of a camera or a light barrier sensor) for detecting a property of the object 2, in particular the diameter of the object 2. The detected characteristic(s) of the object 2 can then serve as input variable(s) for the control circuit 8 and/or the feedforward control 10.

As shown in FIG. 1, a discharge line 12 for discharging support gas can branch off from the support gas feed. In the embodiment shown, the discharge line 12 is connected to a negative pressure generator 13, in particular a vacuum pump. The negative pressure generator 13 can also be controlled by the controller 9 of the control circuit 8 or by a separate control device.

The discharge line 12 can be connected to the support gas feed 5 via the proportional valve 7, whereby the discharge line 12 is decoupled from the support gas feed in a first control range of the proportional valve 7 and is coupled to the support gas feed 5 in a second control range of the proportional valve 7. If the pressure inside the extrudate is too high, the discharge line can be activated by setting the valve, which results in an immediate pressure reduction.

The control circuit 8 can thus be configured in such a way that in a region of the control range, preferably starting in the region of the middle of the control range, support gas is discharged by coupling the discharge line 12 to the support gas feed 5, as a result of which the pressure inside the resulting object 2 is preferably reduced and/or maintained at a target value.

In a particular embodiment of the proportional valve, both a section of the support gas feed 5 extending between the proportional valve 7 and the gas pressure source 17 and the discharge line 12 are flow-coupled to the blow-in opening 6 in at least one position, preferably in a control range, of the proportional valve 7. This makes it possible to achieve a particularly large and finely adjustable operating range with regard to the support gas.

In the discharge line 12, at least one additional valve 14—preferably one that can be controlled manually and/or by a separate controller—can be connected to control the support gas discharge. Similarly, in addition to the proportional valve 7, the support gas feed 5 can have at least one further valve 16—which can preferably be controlled manually and/or by a separate controller—for controlling the support gas. In the embodiment shown, this further valve 16 is connected between the proportional valve 7 and the gas pressure source 17.

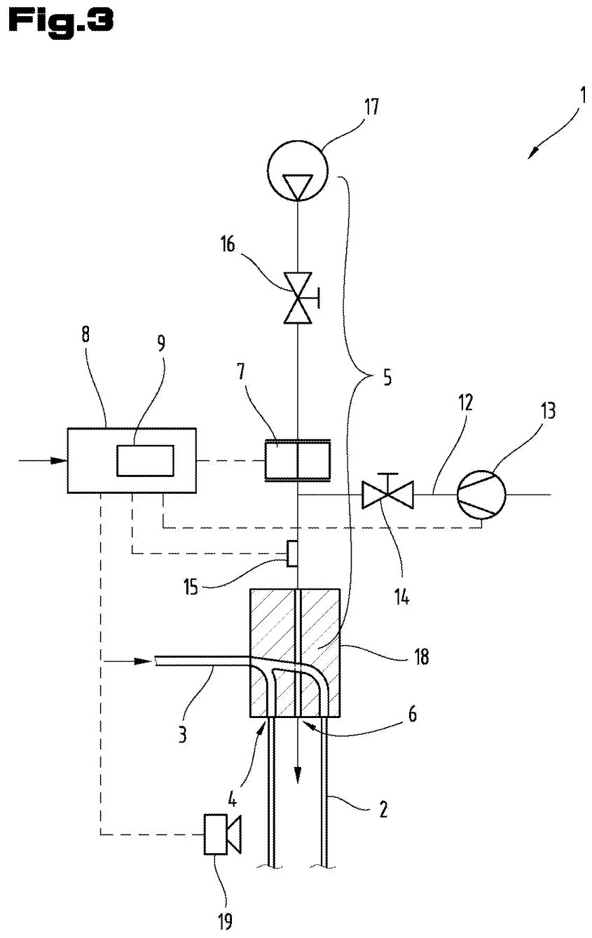

In another embodiment shown in FIG. 3, the discharge line 12 opens into the support gas feed 5 in a region between the proportional valve 7 and the blow-in opening 4. In this case, the connection to the negative pressure generator 13 takes place by means of the valve 14 for controlling the support gas discharge.

In the method for producing an object 2 having a cavity by means of an extrusion device 1, material is now fed to an extrusion nozzle 4 via a material feed 3. The means provided for this purpose (material reservoir, heating, conveyor, etc.) are well known from the prior art. By means of the support gas feed 5, support gas is now introduced into the interior of the resulting object 2 via a blow-in opening 6. As already explained in detail, a proportional valve 7 controlled by a controller is used to regulate the support gas.

FIG. 2 shows in detail how such a control circuit can be configured. Accordingly, the proportional valve 7 is set by a control circuit 8—comprising a controller 9—in which control circuit 8 a detected actual value of a property of the object 2, in particular an actual diameter of the object 2, acts back. Additionally or alternatively, an actual value of the support gas flow can also act back on the control variable of the proportional valve 7. The control circuit 8 in FIG. 2 has a feedforward control 10—superimposed on the controller 9—by means of which a non-linear gas flow characteristic of the proportional valve 7 is compensated—at least partially, preferably completely. By regulating the control variable for the proportional valve 7 in this way, a high and sustainable stability of the support gas flow can now be achieved.

In the embodiment shown, the proportional valve 7 can be controlled by the control circuit 8 in “automatic” mode. However, it can also be operated in a “blow-in” mode or in an “adjustment vacuum” mode. In the latter two modes, a separate controller (e.g. “manually”) can take over the actuation of the proportional valve. This provides all options for reliable operation of the support gas feed 5.

The valves 14 (for suction) and 16 (for blowing in) indicated in FIG. 2 can also be controlled by the control circuit 8 or by a separate controller (see “automatic mode”) or can be set manually in a different operating mode. Valves 14 and 16 (see also FIG. 1) can be solenoid valves, for example.

1. An extrusion device, in particular a blown film extrusion device, for producing an object having a cavity, in particular a tube, a blown film or a container, comprising
a material feed that opens into an extrusion nozzle, and
a support gas feed that opens into a blow-in opening for introducing support gas into the interior of the resulting object,
wherein the support gas feed has at least one valve for regulating the support gas, and
wherein the at least one valve for regulating the support gas is a proportional valve which can be regulated by controller, wherein the proportional valve has a non-linear gas flow characteristic in at least one operating range and the control circuit has a feedforward control superimposed on the controller.

2. The extrusion device according to claim 1, characterized in that the extrusion device has a control circuit—comprising a controller—for setting the proportional valve, in which control circuit a detected actual value of a property of the object, in particular a diameter of the object, and/or an actual value of the support gas flow acts back on the control variable of the proportional valve.

3. The extrusion device according to claim 2, characterized in that the reference variable of the control circuit is a target diameter of the object and/or a target diameter of the object adjusted by a ramp generator.

4. (canceled)

5. The extrusion device according to claim 1, wherein the feedforward control is configured to compensate for a non-linear gas flow characteristic of the proportional valve.

6. The extrusion device according to claim 2, characterized in that a ramp generator is connected upstream of the controller for target value adjustment, the target diameter and the actual diameter of the object preferably being input variables of the ramp generator.

7. The extrusion device according to claim 1, further comprising:
at least one sensor for detecting a property of the support gas flow, preferably the volume flow rate and/or the mass flow rate and/or the gas pressure of the support gas, is arranged in the support gas feed, the detected property or properties of the support gas flow preferably serving as input variable or input variables for the control circuit and/or the feedforward control, and/or
at least one sensor for detecting a property of the object, in particular the diameter of the object, the detected property or properties of the object preferably serving as input variable or variables for the control circuit and/or the feedforward control.

8. The extrusion device according to claim 1, characterized in that a discharge line for discharging support gas branches off from the support gas feed, the discharge line preferably being connected to a negative pressure generator, in particular a vacuum pump.

9. The extrusion device according to claim 1, characterized in that the discharge line is connected to the support gas feed via the proportional valve, the discharge line being decoupled from the support gas feed in a first actuating range of the proportional valve and being coupled to the support gas feed in a second actuating range of the proportional valve,
and/or in that the discharge line opens into the support gas feed in a region between the proportional valve and the blow-in opening.

10. The extrusion device according to claim 1, characterized in that the control circuit is configured in such a way that in a region of the control range, preferably starting in the region of the middle of the control range, support gas is discharged by coupling the discharge line to the support gas feed, as a result of which the pressure in the interior of the resulting object is preferably reduced and/or maintained at a target value.

11. The extrusion device according to claim 1, characterized in that the discharge line is connected to a negative pressure generator, in particular a vacuum pump, the negative pressure generator preferably being actuated by the controller of the control circuit,
and/or in that the support gas feed has a gas pressure source.

12. The extrusion device according to claim 1, characterized in that in at least one position, preferably in a control range, of the proportional valve, both a section of the support gas feed extending between the proportional valve and the gas pressure source and the discharge line are flow-coupled to the blow-in opening,
and/or in that, in at least one operating state of the extrusion device, both the gas pressure source—via the at least partially opened proportional valve—and the negative pressure generator—preferably via at least one at least partially opened valve—are flow-coupled to the blow-in opening, so that support gas can be simultaneously supplied via the support gas feed and discharged via the discharge line, the ratio between the supplied support gas and the discharged support gas preferably being controllable by means of the proportional valve and/or a valve connected in the discharge line and/or a negative pressure generator that can be regulated.

13. The extrusion device according to claim 8, characterized in that at least one valve—which can preferably be actuated manually and/or by a separate controller—is connected in the discharge line to control the support gas discharge.

14. The extrusion device according to claim 1, characterized in that the support gas feed has, in addition to the proportional valve, at least one further valve for controlling the support gas, which valve can preferably be controlled manually and/or by a separate controller, the further valve preferably being connected between the proportional valve and the gas pressure source.

15. The extrusion device according to claim 1, characterized in that the extrusion nozzle and the blow-in opening are integrated in an extrusion head.

16. A method for producing an object having a cavity, by means of an extrusion device, in particular a blown film extrusion device, wherein material is fed to an extrusion nozzle via a material feed and support gas is introduced into the interior of the resulting object via a blow-in opening by means of a support gas feed,
wherein the support gas feed has at least one valve for regulating the support gas,
wherein the at least one valve for regulating the support gas feed-is a proportional valve which can be regulated by a controller.

17. The method according to claim 16, characterized in that the proportional valve is set by a control circuit—comprising a controller—in which a detected actual value of a property of the object, in particular a diameter of the object, and/or an actual value of the support gas flow acts back on the control variable of the proportional valve.

18. The method according to claim 16, characterized in that the control circuit has a feedforward control superimposed on the controller, wherein a non-linear gas flow characteristic of the proportional valve is preferably compensated—at least partially, preferably completely—by means of the feedforward control.

19. The method according to claim 16, characterized in that a discharge line for discharging support gas is connected to the support gas feed via the proportional valve, the proportional valve being controlled between a first control range, in which the discharge line is decoupled from the support gas feed is coupled to the support gas feed, in order to regulate the support gas flow,
and/or in that in a region of the control range, preferably starting in the region of the middle of the control range, support gas is discharged by coupling the discharge line to the support gas feed, whereby preferably the pressure inside the resulting object is reduced and/or maintained at a target value
and/or in that, in at least one operating state of the extrusion device, both the gas pressure source—via the at least partially opened proportional valve—and the negative pressure generator—preferably via at least one at least partially opened valve—are flow-coupled to the blow-in opening, so that support gas is simultaneously supplied via the support gas feed and discharged via the discharge line, the ratio between the supplied support gas and the discharged support gas preferably being regulated by means of the proportional valve and/or a valve connected in the discharge line and/or a negative pressure generator that can be regulated.

20. The method according to claim 16, characterized in that the extrusion device is configured to include:
a material feed that opens into an extrusion nozzle, and
a support gas feed opens into a blow-in opening for introducing support gas into the interior of the resulting object,
wherein the support gas feed has at least one valve for regulating the support gas, and
wherein the at least one valve for regulating the support gas is a proportional valve which can be regulated by a controller, wherein the proportional valve has a non-linear gas flow characteristic in at least one operating range and the control circuit has a feedforward control superimposed on the controller.
